(19) United States
(12) Patent Application Publication
(10) Pub. No.: US 2011/0147309 A1
(43) Pub. Date: Jun. 23, 2011

(54) PROCESS FOR THE DESALINATION AND ELIMINATION OF BORON FROM WATER AND EQUIPMENT TO CARRY OUT SAID PROCESS

(76) Inventors: Enric Palacios Doñaque, Madrid (ES); Manuel Fariñas Iglesias, Madrid (ES); Alejandro Zaruela López, Madrid (ES)

(21) Appl. No.: 12/977,118

(22) Filed: Dec. 23, 2010

Related U.S. Application Data
(63) Continuation of application No. PCT/ES2009/070256, filed on Jun. 26, 2009.

(30) Foreign Application Priority Data
Jun. 26, 2008 (ES) P200801910
Oct. 22, 2008 (ES) P200802978

(51) Int. Cl. C02F 1/44

(52) U.S. Cl. 210/652; 210/321.64

(57) ABSTRACT

The present invention relates to a method for performing desalination and eliminating boron from water, which comprises carrying out a first reverse-osmosis step where the saline water is supplied into a reverse-osmosis membrane container which comprises a plurality of membranes interconnected in series, arranging between two of said membranes a blind interconnector which separates the flows of permeate in two membrane sections, i.e. the flow situated upstream of the blind interconnector and the flow situated downstream of the blind interconnector, defining two respective stages, and carrying out at least one second reverse-osmosis step which comprises low-pressure and high-flow membranes or medium-pressure and medium-flow membranes and which is supplied with some or all of the water obtained from the permeate of the membranes of the first step which are situated upstream of the blind interconnector, i.e. the first stage of the first step.

### OBJECT OF THE INVENTION

This invention falls within the processes for the desalination and elimination of boron from seawater and brackish water and the equipment required to carry out said processes.

Therefore, it is also object of the present invention to improve the energy efficiency of the equipment for carrying out processes of desalination and elimination of boron from seawater and brackish water, minimising the flow of brine rejection and minimising energy consumption.

### TECHNICAL FIELD OF THE INVENTION

This invention is of application in the industry of water desalination, more specifically applicable in the purification and desalination of seawater.

### PRIOR ART

Currently, the processes for eliminating boron from seawater are performed using reverse osmosis membranes and combined systems of membranes and ion exchange polymer resins.

The boron content in seawater ranges between 3.5 and 7 ppm (parts per million). In general, seawater membranes have low boron rejection, and therefore the content of this element in the permeated water does not meet the current regulation of 1 ppm for water for human consumption and for some agricultural uses. On the other hand, the World Health Organisation (WHO) recommends that the boron content in water must not exceed 1 ppm and it is expected to be reduced in the future to 0.5 ppm of boron for some uses.

Very specialised techniques have therefore been developed with reverse osmosis membranes to eliminate boron from seawater and reach the contents established by the regulations on treated waters.

Therefore, the most common technique for eliminating boron from water for human consumption and agricultural uses derived from seawater consists in the use of plants equipped with reverse osmosis steps with membranes, wherein a first step is performed with seawater membranes and a second step is performed with brackish water membranes.

The seawater is therefore treated by a first step of high-pressure reverse osmosis membranes, where most of the salts and therefore also a certain percent of the boron are removed. In general, a concentration of boron is obtained in the treated water (hereinafter permeated water) that ranges between 0.7 and 1.5 ppm, depending on the temperature of the water. It is also worth highlighting that reverse osmosis membranes lose their capacity of eliminating salts and boron over time and with the successive washouts they are subjected to.

Experience demonstrates that the boron content in permeated water can exceed the current limit of 1 ppm.

Moreover, as we have mentioned above, the regulations are expected to change in order to lower the boron content allowed in drinking water to 0.5 ppm.

We therefore achieve a process for eliminating boron that allows guaranteeing from the start that the boron content in permeated water will never exceed the current limit of 1 ppm and will allow obtaining boron concentrations below 0.5 ppm. This process ensures that the content obtained will not vary with the kind of operation or with the successive chemical washouts of the desalination plants.

To do this, we have designed plants with a second step of low-pressure, high output brackish water reverse osmosis membranes. This solution consists in taking part of the permeated water obtained from the first step of high-pressure reverse osmosis membranes, increasing the pH to values of 10-11 by adding sodium hydroxide or another strong base and adding a scale inhibiting agent and then pumping it to a second step. The permeated water obtained from the first step and the second step is mixed in suitable proportions to minimise the boron content in the water resulting from the treatment. This system is detailed in FIG. 1.

Using these systems, all or part of the water from the first step of reverse osmosis membranes is treated by the second step of reverse osmosis membranes after being pumped from the first to the second step.

Additionally, we must consider that reverse osmosis plants have many pressure containers to house the membranes, which are connected in series by interconnectors. These pressure containers may house 6, 7, 8 or more membranes connected in series. Moreover, in a reverse osmosis plant there are many containers mounted in parallel that make up what is called the membrane rack.

The seawater is fed through one face of the pressure container and the concentrated salt water is collected at the rear face of the container and the water with low salt content and low boron content is collected in the centre of the container from all the membranes, which are interconnected in series via the central tube.

Therefore, the total boron content corresponds to the mixture of the boron contents from the independent flows of permeated water from each membrane located in the pressure container. And the boron concentration in the permeated water increases from the first to the last membrane. FIG. 2 shows a standard diagram of a first-step pressure container in a standard system such as the one described above.

In short, in current systems part of the permeated water from the first step, which is a mixture of the permeates from all the membranes in said step, is pumped to the second step. This pumping involves important energy costs and is due to the fact that the pump that drives the permeated water from the first step to the second step must be sized in order to overcome the osmotic pressure of the permeated water from the first step as well as the specific resistance offered by the container membranes of the second step in order to provide the desired flow of permeate.

Therefore, the pressure containers or reverse osmosis membrane containers arranged in each step must house inside them the reverse osmosis membranes connected in series, collecting the permeated water at one end of the container, which implies that the salt content of the permeated water obtained from the set of membranes installed in each container is the gradual mixture of all the salts that cross the membranes. Since the last membranes are the ones that allow the passage of the most salts, the permeated water therefore has osmotic pressure.

Moreover, in all reverse osmosis processes, the salinity of the permeates from the membranes increases with their position in the tube or pressure container. This means that the permeated water from the first step has osmotic pressure and a certain working pressure must be applied in the second step in order to overcome said osmotic pressure and the specific resistance of the membranes.

It was therefore desirable to obtain a process of desalination and boron elimination of seawater that would avoid the use of a pump to feed the second step, especially a booster pump or a pump that increases pressure.

### DESCRIPTION OF THE INVENTION

This invention, therefore, intends to avoid the use of a pump to feed the second step, especially a pressure increasing pump or a booster pump, seeking a high energetic yield or minimum energy costs. That is, this invention manages to carry out a process for the desalination and boron elimination of seawater using a reverse osmosis system that allows avoiding the use of a pump to feed the second step. These systems work by taking a percentage of the total permeate flow from the first step, which is treated in a second step using brackish water membranes, instead of taking 100% of the permeate flow from the first step.

To do this, a blind interconnector, also called a blind split, is placed inside the pressure container of the first step, inside the permeate tube and in different positions between two of the membranes existing inside each pressure container, in order to separate the permeate flows. The pressure container therefore works as if were to work in two stages, thus producing two permeated water currents from both ends of the pressure container with different boron contents.

Therefore, having a blind interconnector allows separating the permeated flows from the first step in order to subsequently treat any of these in a second step of reverse osmosis membranes.

Having determined the position of the blind interconnector within the permeated duct of the first step, we can then consider that the permeate flows are divided as if they were from two stages.

The position of the blind interconnector separating the membranes will depend on the flow to be obtained from each group of membranes, the permeate pressure required and the boron content required in each permeate.

Additionally, the workflow of the permeate flow of each membrane section can be adjusted, if necessary, by exerting a counter pressure that can be of different values by valves installed in each part of the permeate duct.

The second membrane step is therefore fed with the pressure offered by the permeate current from the first stage of the first step itself. This second step is the second step of the first stage of the first step.

This second step uses low pressure and high flow membranes.

In a particular embodiment, the blind interconnector is placed between the membranes in positions 3 and 4 and the part or section of the membrane tube that produces the smallest amount of boron is that comprised between the membranes in positions preferably from 1 to 3 of the first step.

In a second particular embodiment, the blind interconnector is placed between the membranes in positions 4 and 5 and the part or section of the membrane tube that produces the smallest amount of boron is that comprised between the membranes in positions preferably from 1 to 4 of the first step.

The flow from this stage is the flow that will be used to feed the second step of the first stage of the first reverse osmosis step without an intermediate feeding pump for said second step, that is, without the need of a pressure-increasing pump or a booster pump.

Optionally, sodium hydroxide, or a strong base, can be dosed into the input water of said second step in order to raise its pH to values preferably of 10 and 11, since the boron from the permeated water is in the form of boric acid. This alkalinization is advisable in order to transform the boric acid into the borate ion, which is the one that is best rejected by the brackish water membranes. This produces better boron elimination. Similarly, a scale-inhibiting/dispersing agent can be introduced in order to prevent the possible formation of deposits.

Therefore, according to the above, this invention relates, first of all, to a process for the desalination and elimination of boron from water, preferably from seawater, which is characterised in that it comprises:
performing a first reverse osmosis step by feeding seawater or brackish water to reverse osmosis membranes housed in a membrane container comprising a plurality of membranes that are interconnected in series to work at either high or low pressures, according to the application for either seawater or brackish water, and where between two of these membranes a blind interconnection interconnector is previously placed that separates the permeate flows in two membrane sections, those before the blind interconnector and those after the blind interconnector, respectively defining two stages;
performing at least one second reverse osmosis step comprising low pressure and high flow membranes or medium pressure and medium flow membranes, which is fed with part of the water from the permeate from the first step membranes before the blind interconnector, that is, the first stage of the first step.

Moreover, the brackish water or seawater is fed to the first step by standard pumping means, such as a high pressure pump.

Moreover, the membrane container of the first step can contain 6, 7, 8 or more membranes and the blind interconnector can be placed between any two of these membranes, preferably between membranes 3-4, 4-5 or whichever necessary.

In a particular embodiment, up to 8 membranes can be placed inside a pressure container and the blind interconnector is placed between the membranes in positions 3-4 or 4-5.

The membranes before the blind interconnector provide the greatest flow of treated water, with very low salinity with respect to the mixture that would be obtained if the blind interconnector were not placed between two membranes. It is therefore possible to feed the second step of the first stage of the first step without the need for an intermediate pump to increase pressure.

Additionally, the workflow of the permeate flow in the first membrane step can be adjusted by using valves to regulate the permeate flow of the two sections separated by the blind interconnector. Said valves are installed on each side of the permeate duct to provide counter pressure on the permeate duct of the membranes of both the first and the second stages of the first step. This produces two effects: it acts on the conversion (the ratio between the flow of permeated water and water to be treated fed to the membrane pressure container) of the first step and controls the workflow of the first membranes of the first step, that is, those before and after the blind interconnector.

Thus, by regulating the workflow using these valves, we regulate the flow of permeate from the membranes before and after the blind interconnector, and at the same time regulate the working conversion of both stages of the first step.

As mentioned above, when necessary sodium hydroxide or a strong base, or a strong base and a scale inhibitor agent can be added to the process into the feed of the second step, said feed coming from the membranes of the first stage of the first step, that is, the permeate current from the membranes before the blind interconnector. This is performed in order to increase the pH to preferably between 10 and 11, to obtain better boron elimination and prevent the possible formation of deposits on the membranes of the second step.

In a second variant of the process of boron elimination from water described above, when performing the at least one second reverse osmosis step, it is also fed with part of the water from the permeate of the first step membranes after the blind interconnector, that is, there is a second step also for the water from the second stage of the first step.

This second variant involves an additional stage of transferring the pressure existing in the rejection water of the first step to the feed of said first step. This pressure transfer is performed by means of a pressure exchanging hydraulic device that is inserted before the feed of the second step and uses the pressure of the rejection brine from the first step.

In a third variant of the process of boron elimination from water described above, the pressure of the water from the second stage of the first step fed to a second step, which we shall call the second step of the second stage of the first reverse osmosis step, is reinforced by a pump with very low energy consumption that is installed in bypass.

Additionally, we consider the following alternative solution to the process described above, in order to guarantee a boron concentration of less than 0.5 ppm in the permeated water.

In the second embodiment, the water sent by a pump or by the permeate pressure to the second step of the second stage of the first step is the water produced by the second stage of the first step.

A fourth embodiment or variant of the invention refers to a process consisting in a first reverse osmosis step in two stages, such as the one described above, and two second reverse osmosis steps applied as described below. In order to simplify the names of the two second reverse osmosis steps, we shall call them second step of the first stage of the first step and second step of the second stage of the first reverse osmosis step.

Therefore, in this fourth variant, the process takes into account that the permeated water from the first stage of the first step, i.e. the one corresponding to the group of membranes before the blind interconnector, feeds the first of the second steps, i.e. the one called the second step of the first stage of the first step. Said second step comprises the passage of the liquid through two or three membranes steps, the membrane containers being formed by high flow and low-pressure membranes or medium flow and medium pressure membranes, such that they do not require pumping means.

The entire rejection from the second step of the first stage of the first step is mixed with the permeate of the second stage of the first step. The resulting mixture feeds the second step of the second stage of the first step, which also consists in two or three stages of membrane containers, of high flow and low pressure or medium flow and medium pressure.

Alternatively, a booster pump or low pressure pump can be inserted in bypass to feed the second step of the second stage of the first step.

Therefore, the global permeate of the process of the invention in this fourth variant is the mixture of the global permeates obtained at the outlet of the second step of the first stage of the first step and from the second step of the second stage of the first step.

On the other hand, the global flow rejection from the second step of the second stage of the first step is sent to the aspiration of the seawater pump that feeds the entire reverse osmosis system. Therefore, the seawater undergoes dilution and its osmotic pressure therefore decreases, and as a result the total feed pressure to the membranes of the first step also decreases, which thus producers important energy savings.

Alternatively, in order to improve the energy efficiency even further, an energy regenerator can be installed that feeds from the rejection of the first step, using the movement of this rejection to propel another flow. The flow propelled by the energy regenerator comes from the aspiration of brackish water or seawater. Moreover, it is provided that the energy regenerator device feeds a low-pressure booster pump which will once again propel the water exiting the energy regenerator to the first step.

The process described above, in its four variants, can be used in any kind of water that requires desalination and boron elimination, but has been conceived preferably to treat seawater or brackish water and will be used preferably to desalinate seawater.

At all times throughout this specification, when we speak of a second step it is important to consider that this second step can have two, three or four stages, despite only the case of two stages having been described in detail. Similarly, each of these stages can be formed by any amount of membrane containers necessary according to the installation to be built. The different variants described have not shown specific variants on the amount of membrane containers in the second steps because these are schematic representations. The amount of membrane containers in each stage responds to the specific needs of each installation.

This invention also relates to equipment to perform a process of desalination and boron elimination from water as defined above, characterised in that it comprises at least:

one container of reverse osmosis membranes comprising a plurality of membranes interconnected in series, the membranes being low-pressure membranes (low power consumption) and high rate in order to work at low pressure, or medium rate medium pressure membranes;

a blind interconnector arranged between two membranes in each membrane container in which the first step is performed, such that said interconnector separates the permeate flows of two membrane sections or stages; and

at least two flow regulation valves installed on each side of the permeate duct of the first step in order to produce counter pressure in the permeate ducts of each membrane section separated by the blind interconnector.

In a particular embodiment of the equipment, up to 8 membranes are placed inside each membrane container in which the first step will be performed, and the blind interconnector is placed between the membranes in positions 3-4 or 4-5.

In a first variant, the equipment described above also comprises a hydraulic pressure-transfer device inserted in the feed of the second step, just before its inlet.

In the second variant, the equipment described above comprises, as well as the hydraulic device mentioned in the first variant, a low power consumption pump installed in bypass after said hydraulic pressure transfer device and before the start of the second step.

In a third variant, the equipment described above also incorporates a low power consumption from installed in bypass after the hydraulic pressure transfer device and before the feed of the second step. This pump is used to boost the feed pressure for the second step.

In a fourth variant, the equipment described above also incorporates an additional membrane container or a group of membrane containers, corresponding to the second step of the second stage of the first step.

In this fourth variant, the equipment may incorporate an energy regenerator in the rejection from the first step and a booster pump that boosts the water coming from the energy regenerator to the first step.

Using the equipment for performing the process of desalination and boron elimination from water described above we achieve energy savings since energy is recovered from the first step in the system. The fact of feeding a second step using permeated water from the first stage of the first step without using any pumps offers substantial power savings since it allows using the pressure of the permeate flow from the first stage of the first step. Moreover, the global rejection from the second step of the second stage of the first step is mixed with the seawater at the aspiration of the high pressure pump that feeds the first membrane step, which leads to a decrease in the concentration of salts in the water pumped into the first membrane step with a lower pumping pressure and the resulting energy savings.

### BRIEF DESCRIPTION OF THE DRAWINGS

This invention will be entirely understood on the bases of the brief description below and the set of drawings enclosed, only as an example, and which are therefore not restrictive within this invention, and in which:

FIG. 1 shows a flow chart of a standard two-step system, existing in the prior art,

FIG. 2 shows a flow chart for the first step of a standard system of flow distribution in a membrane tube, existing in the prior art,

FIG. 3 shows a diagram in the inside of a membrane container from the first step comprising a plurality of membranes interconnected in series for the desalination and boron elimination system of the present invention with a blind interconnector (2),

FIG. 4 shows a diagram of the desalination and boron elimination system of the present invention in its first variant,

FIG. 5 shows a diagram of the desalination and boron elimination system of the present invention in its second variant, which includes a hydraulic pressure-transfer device (12),

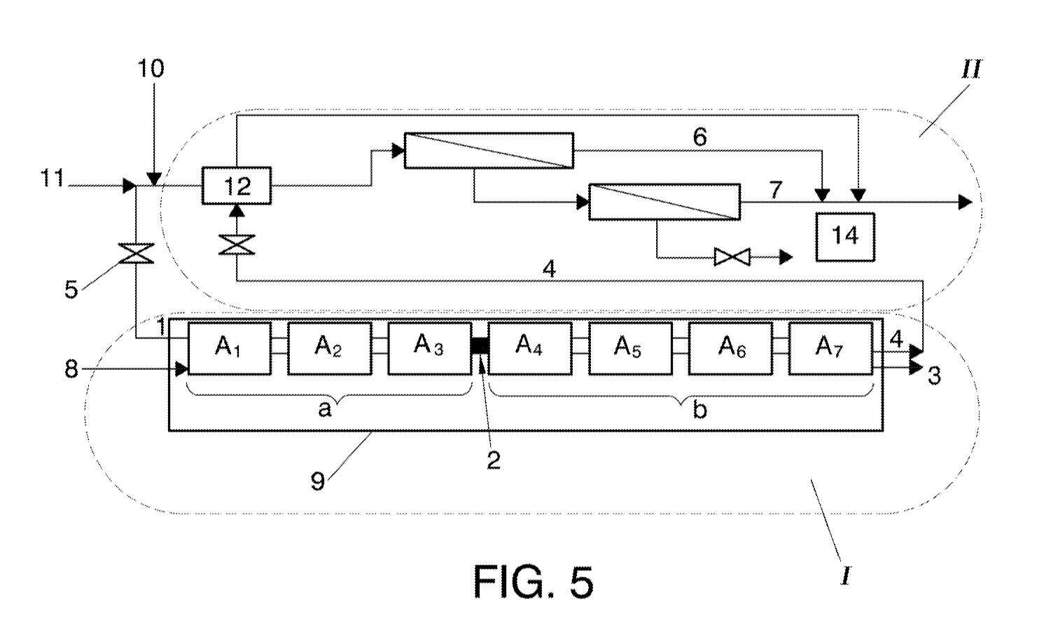

FIG. 6 shows a diagram of the desalination and boron elimination system of the present invention in its third variant, which includes a hydraulic pressure-transfer device (12) and a pump (13), and

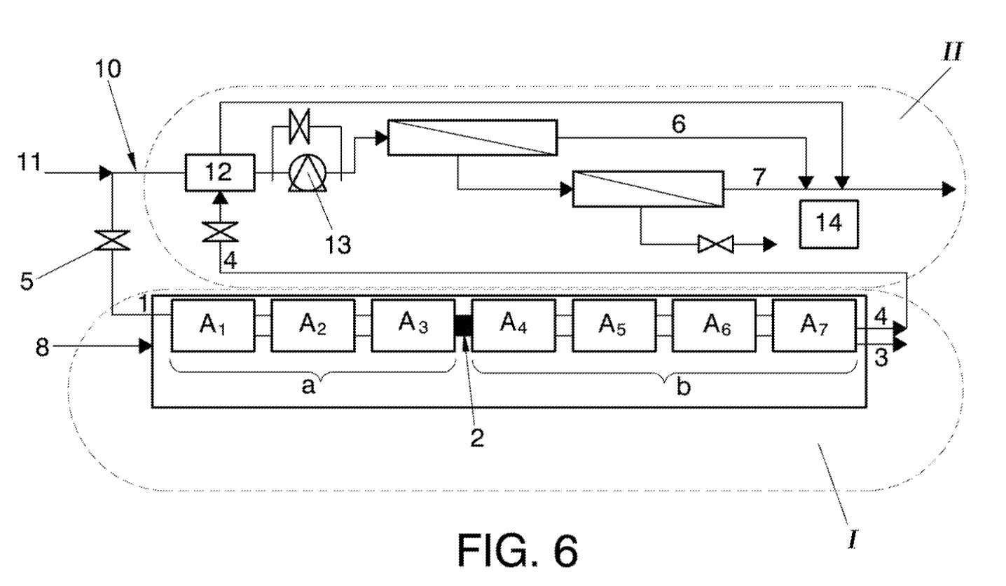

FIG. 7 shows a diagram of the desalination and boron elimination system of the present invention in its fourth variant, which includes two second steps (IIa and IIb) of reverse osmosis in two stages and an energy regenerator (26).

### EMBODIMENT OF THE INVENTION

In order to reach a better understanding of the object and functionality of this patent, and without these understood as restrictive solutions,

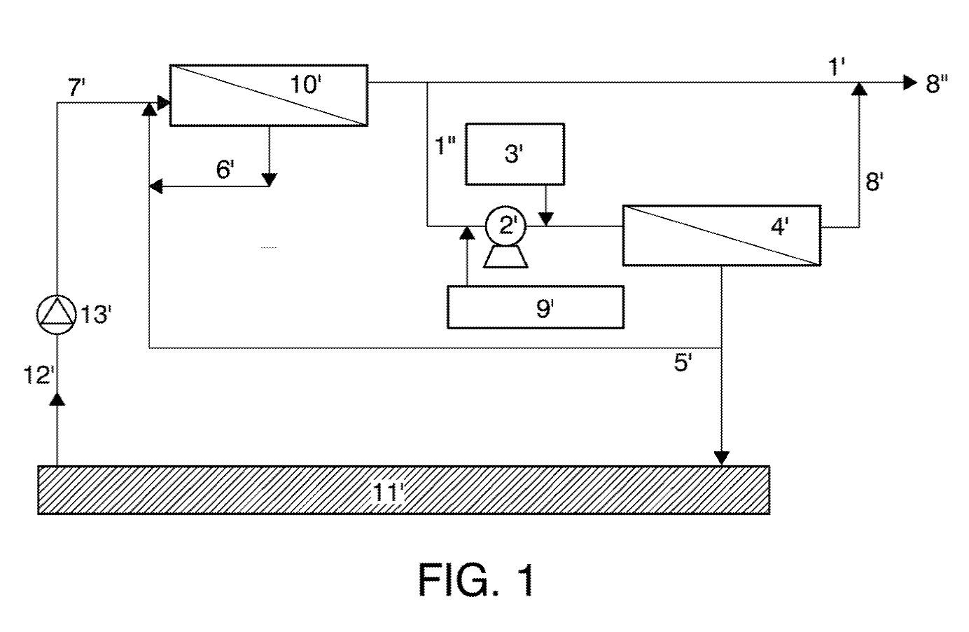

FIG. 1 shows a flow chart of a standard two-step system (10′ and 4′), existing in the prior art, in which we can observe the aspiration (12′) of the system from the brackish water or seawater (11′), the high-pressure pump (13′) and the feed/input into the container from the first step (10′). Also shown is the path followed by the permeate obtained in the first stage of the first step (1′), the feed pump (2′) that feeds this water to the second step and the optional addition of sodium hydroxide (3′) or another strong base and a scale inhibitor (9′) before the start of the second step (4′). Also shown is the final obtaining of the rejection from the second step (5′) that is joined to the rejection from the first step (6′) and redirected to the feed of the first step (7′). On the other hand, and simultaneously, we obtain, at the end of the second step, the permeate (8′) to which the permeate from the first step (1′) is added, forming the total permeate (8″) of the system.

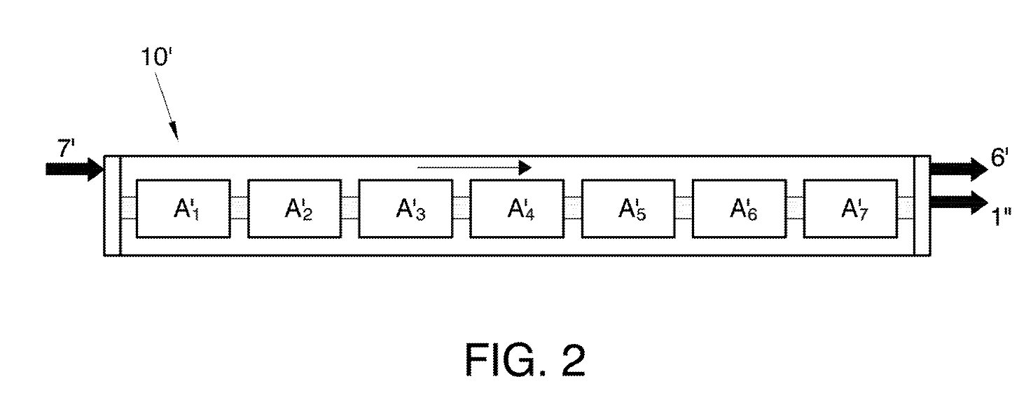

FIG. 2 shows a flow chart and the distribution of membranes in the first step of a standard two-step system, existing in the prior art and in which we can see the position of the plurality of membranes (A1′, A2′, A3′, A4′, A5′, A6′ and A7′) arranged in the pressure container (10′). It also shows, the location of the water feed (7′) and the direction of the currents produced, form which the current that crosses the first membranes produces the permeate from the first step (1″), which passes to feed the second step of the process and the water, rejection from the first step (6′).

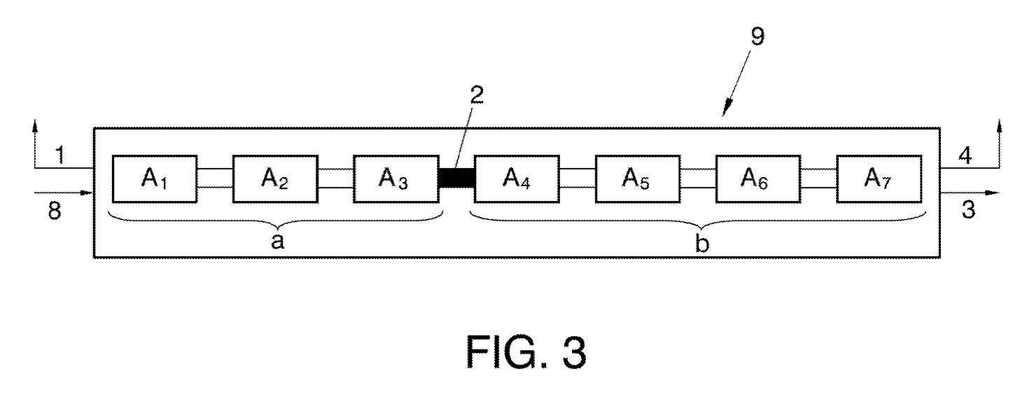

FIG. 3 shows a diagram of a configuration of a membrane container (9) with a blind interconnector or blind split (2) according to this invention. The membranes (A1, A2, A3, A4, A5, A6 and A7) housed in the containers (9) are thus separated into two groups or stages (a and b). The number of membranes is preferably 7 or 8, and the container can be connected at any position between two membranes, preferably at positions A3-A4 or A4-A5. The membrane container (9) with a blind interconnector (2) allows obtaining two permeate flows: a permeate flow (1) from the first stage (a) and a permeate flow (4) from the second stage (b), and the container (9) releases a flow rejection (3).

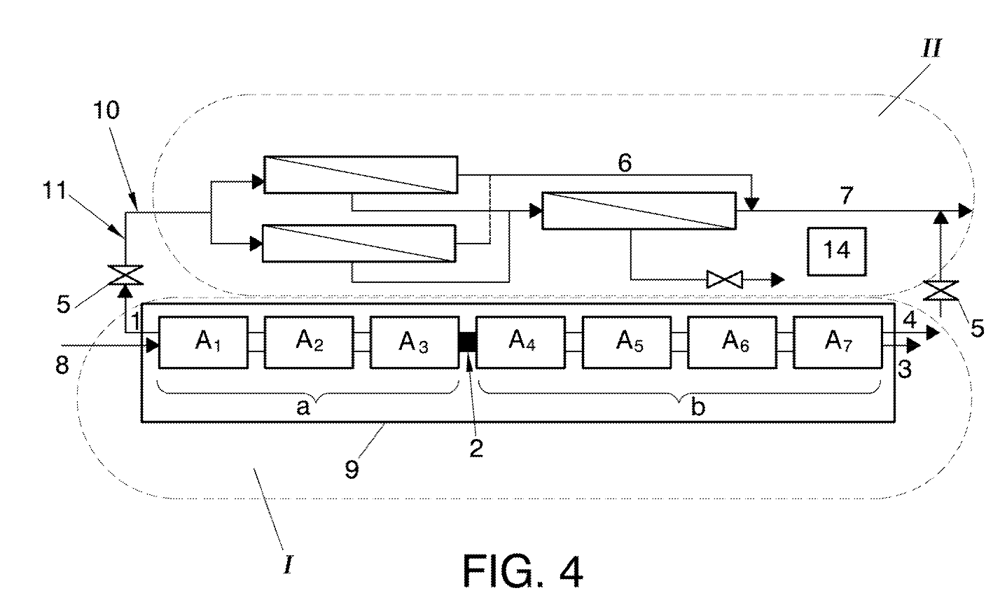

FIG. 4 shows a diagram of the desalination and boron elimination system described in this invention, showing the path followed by the permeate (1) obtained in the first stage (a) of the first step (I), the position of the plurality of membranes (A1, A2, A3, A4, A5, A6 and A7) arranged in the pressure container, or membrane container (9) and the blind interconnector (2) located in the preferred position, between the membranes at positions A3 and A4. Therefore, the current of the membranes at the other side of the blind interconnector (2) produces the permeate (4) of the second stage (b) and the rejection (3) of the first step (I). This rejection (3) from the first step (1) can either be partially recycled at the input of the first step, or evacuated as brine into the sea, as appropriate.

We can therefore see the division of the permeate flows from the first step of the reverse osmosis of seawater with a blind interconnector (2).

The part of the membrane container (9) that produces the greatest flow is, in this particular embodiment in which the blind interconnector (2) is located between the membranes at positions A3 and A4, that from the membranes at positions A1 to A3. This flow (1) is the flow that will be used to feed a second step (II, IIa) of reverse osmosis without an intermediate pressure raising pump (booster pump), used with low pressure and high rate membranes or medium rate and low pressure membranes. Part of the rejection or the entire rejection from the second step will be sent to the header of the reverse osmosis plant.

The advantages of the process of the invention are the following:
not using a booster pump to feed the permeated water (1) from the first stage (a) of the first step (I) to a second step (II, IIa) and the resulting energy savings;
Obtaining values of boron content in the total permeate of less than 1 ppm, based on an initial boron concentration in seawater of between 3.5 and 7 ppm, and at any temperature of the seawater;
the counter pressure necessary to obtain a good yield from the membranes is achieved using rejection valves (5) located at both sides of the first step (I), thus achieving: acting in the conversion of the second step and controlling the workflow of the membranes at positions, for example, A1 to A3 or A1 to A4 of the different special embodiments suggested for the first step; and
the permeated water (4) from the second stage (b) of the first step (I) and from the two stages of the second step (6 and 7) are appropriately mixed until obtaining boron concentrations always of less than 1 ppm.

Using the process described in this invention we can perform appropriate mixtures of each permeate flow both from the first and from the second step in order to obtain a low overall boron concentration in the water for use.

Moreover, by working with low pressure and high rate or medium pressure and medium rate membranes in the second step, we can work at very low pressures in this step, which prevents the installation of a booster pump at the input with the resulting energy savings.

An additional advantage of working with low pressure and high rate or medium rate and medium pressure membranes both in the first step (I) and in the second step (II, IIa), is that they provide a suitable counter pressure in the permeate currents of the first stage (a) of the first step (I) and of the membranes at positions preferably from A1 to A3, that is, the ones located before the blind interconnector (2) in one of the preferred embodiments described.

By working with a blind interconnector (2) or blind split between the membranes at positions A3-A4 or A4-A5 of the first step (I) and treating the permeated water produced by these membranes, the permeated water (1) in the first stage (a) of the first step (I) has very low salinity, that is, low osmotic pressure, and therefore the working pressure in the second step (II, IIa) of the first stage (a) of the first step (I) described in this process is also low.

By working without a booster pump in the feed of the second step we achieve a process of desalination and boron elimination by reverse osmosis with low energy costs.

The fact that all the flows of rejection water from the second step are sent and mixed with the input flow of seawater in the first step, thus decreasing the osmotic pressure of the input to the system and therefore the working pressure, with the resulting energy savings, also contributes to this fact.

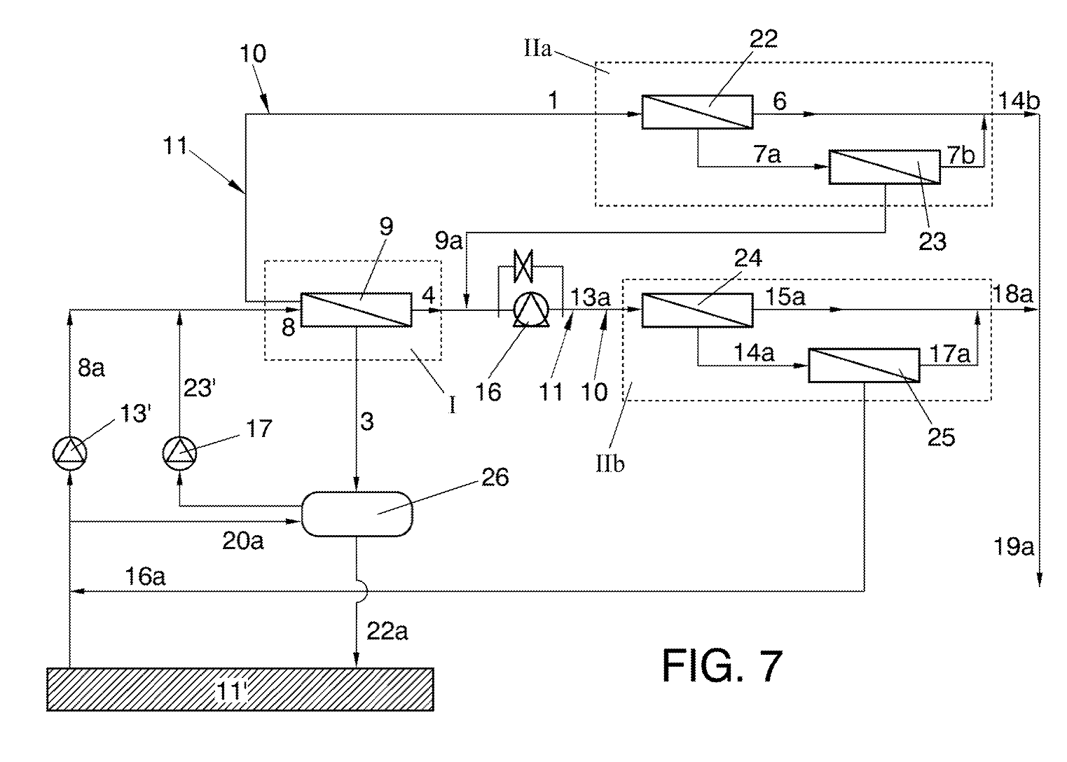

FIG. 7 shows the fourth variant proposed for this invention, in which the process consists in a first step (I), a second step (IIa) of the first stage (a) of the first step (I) and a second step (IIb) of the second stage (b) of the first step (I).

The first step (I) comprises a container (9) with a blind interconnector (not shown in FIG. 7, shown in FIG. 3) that is fed with the flow (8) that is the mixture of the flow (8a) from the brackish water or seawater (11′) propelled using a high-pressure pump (13′) and a flow (23′) from an energy regenerator device (26) that is propelled by a booster pump or a low pressure pump (17).

The permeated water (1) of the first step (a) from the membrane container (9) of the first step (I) directly feeds, without using any additional pumping means, a reverse osmosis membrane container (22) corresponding to a first stage of the second step (IIa) of the first stage (a) of the first step (I).

The rejection (7a) from the first stage of the second step (IIa) of the first stage (a) of the first step (I) feeds the membrane container (23) corresponding to a second stage of the second step (IIa) of the first stage (a) of the first step (I).

The mixture of permeates (6 and 7b) from the first and second stages of the second step (IIa) of the first stage (a) of the first step (I) forms the overall permeate (14b) of the second step (IIa) of the first stage (a) of the first step (I).

On the other hand, the permeate (4) from the second stage (b) of the first step (I) is mixed with the rejection (9a) from the second stage (second container 23) of the second step (IIa) of the first stage (a) of the first step (I) producing a flow that is propelled using a booster pump or low pressure pump (16) and feeds (13a) the reverse osmosis membrane container (24) corresponding to the first stage of the second step (IIb) of the second stage (b) of the first step (I).

The rejection (14a) from the first stage of the second step (IIb) of the second stage (a) of the first step (I) feeds the reverse osmosis membrane container (25) corresponding to the second stage of the second step (IIb) of the second stage (b) of the first step (I).

The mixture of the permeates (15a and 17a) from the first and second stage of the second step (IIb) of the second stage (b) of the first step (I) forms the overall permeate (18a) of the second step (IIb) of the second stage (b) of the first step (I).

The mixture of overall permeates (14b and 18a) from the second steps (IIa and IIb) forms the overall permeate (19a) of the process described in this fourth variant of the invention.

The membrane containers (22, 23, 24 and 25) of the seconds steps (IIa and IIb) consist in high rate and low pressure or medium rate and medium pressure membranes.

The rejection (16a) from the second stage of the second step (IIb) of the second stage (b) of the first step (I) is sent to the aspiration flow (8a) of the first step (I) such that there is a dilution of the aspirated brackish water or seawater, therefore reducing the osmotic pressure by producing a lower concentration of salts and therefore requiring a lower pumping pressure of drum, with the corresponding savings in energy.

Similarly, and in order to obtain a high efficiency in this fourth variant of the invention, an energy regenerator device (26) is installed. Said energy regenerator (26) receives the overall rejection (3) from the first step (I). This is a because the overall rejection (3) from the first step (I) has high convertible energy.

Therefore, the energy regenerator (26) transforms the kinetic energy of the rejection (3) into energy that is provided to the suction of a pump (17). The energy regenerator (26) receives, in turn, a flow (20a) of seawater or brackish water from the aspiration (8a) of the high-pressure pump (13′).

The flow (23′) is the flow that exits the energy regenerator (26) and is propelled by the booster pump or low pressure pump (17) towards the input of the membrane container (9) of the first step (I). The mixture of this flow (23′) with the flow (8a) that propels the pump (13′) forms the input flow (8) of the membrane container (9) with the blind interconnector (2, not shown in FIG. 7) of the first step (I).

Finally, there is a rejection flow (22a) that has crossed the energy regenerator (26) and which forms the discharge flow of rejection brine.

Additionally, as mentioned above for other embodiments, this fourth embodiment includes the possibility of adding scale inhibitor to prevent the precipitation of salts, as well as adding a base to increase the pH of the mixture of water of the permeate current (1) from the first stage (a) of the first step (I) and to the permeate current (13a) from the permeate flow (4) from the second stage (b) of the first step (I) and form the rejection (9a) form the second step (IIa) of the first stage (a) of the first step (I). The boron is thus transformed into borate, which is much better rejected by the high rate low pressure or medium rate medium pressure reverse osmosis membranes.

Therefore, the process and the equipment described in this invention offer high quality permeated water regarding its salinity and boron elimination at a low energy cost.

It has been experimentally verified that the fourth variant of this invention allows obtaining overall conversions of 46-48%, with partial conversions of 40-50% in the first step (I) and of 90% in the second steps (IIa and IIb).

Moreover, the configuration of the reverse osmosis equipment for desalinating and eliminating boron from seawater or brackish water of the present invention offers the advantage of having a minimum flow of rejection brine.

1. A process for the desalination and elimination of boron from water characterised in that it comprises:
performing a first step (I) of reverse osmosis by feeding brackish water (8) into a reverse osmosis membrane container (9) comprising a plurality of membranes (A1, A2, A3, A4, A5, A6 and A7) that are interconnected in series, and between two of which membranes is placed a blind interconnector (2) that separates the permeate flows into two membrane sections, those that are before (a) the blind interconnector (2) and those after (b) the blind interconnector (2), respectively defining two stages (a and b);
performing at least one second step (II, IIa) of reverse osmosis within at least two membrane containers (22 and 23) comprising low pressure and high rate or medium pressure and medium rate membranes that are fed with part or all the water from the permeate (1) of the membranes from the first step (I) that are before (a) the blind interconnector (2), that is, the first stage (a) of the first step (I).

2. A process for the desalination and elimination of boron from water according to claim 1, characterised in that in the first step (I) there are 6, 7 or 8 membranes placed in the membrane container (9).

3. A process for the desalination and elimination of boron from water according to claim 1, characterised in that in the first step (I) there are 7 membranes (A1, A2, A3, A4, A5, A6 and A7) placed inside the membrane container (9) and the blind interconnector (2) is placed between the membranes at positions A3-A4 or A4-A5.

4. A process for the desalination and elimination of boron from water according to claim 1, characterised in that in the first step (I) the workflow of the permeate is regulated by flow-adjustment valves (5) that are installed on each side of the membrane container (9).

5. A process for the desalination and elimination of boron from water according to claim 1, characterised in that in the second step (II) sodium hydroxide (10) or a strong base and a scale inhibitor (11) are added to a feed current (1) of this step, said current (1) being the result of the membranes from the first (a) stage of the first step (I) in order to increase the pH.

6. A process for the desalination and elimination of boron from water according to claim 1, characterised in that the water to be treated (8) is seawater or brackish water.

7. A process for the desalination and elimination of boron from water according to claim 1, characterised in that when performing the second step (II) of reverse osmosis this step is also fed with part of the water from the permeate (4) of the membranes from the first step (I) that are after the blind interconnector (2), that is, the permeated water from the second stage (b) of the first step (I).

8. A process for the desalination and elimination of boron from water according to claim 7, characterised in that the residual pressure in the permeate water (1) of the first stage (a) of the first step (I) is transferred to the permeate (4) of the second stage (b) of the first step (I) by means of a hydraulic pressure-transfer device (12) that is inserted before the feed for the second step (II).

9. A process for the desalination and elimination of boron from water according to claim 8, characterised in that the feed pressure of the second step (II) is boosted via a low-energy consumption pump (13) installed after the hydraulic pressure-transfer device (12) and before the feed of the second step (II).

10. A process for the desalination and elimination of boron from water according to claim 1, characterised in that
in the first step (I) the membrane container (9) is fed by an input flow (8) produced by the mixture of an aspiration flow (8a) of brackish water or seawater (11′) propelled by a high-pressure pump (13′) and a flow (23′) from an energy regenerator device (26);
in the second step (IIa) at least two reverse osmosis membrane containers (22 and 23) are arranged in order to define a first and a second stage respectively, the first stage being fed with permeate (1) from the first stage (a) of the first step (I) and in that it also comprises another second step (IIb) corresponding to the second stage (b) of the first reverse osmosis step (I) in which at least two reverse osmosis membrane containers (24 and 25) are placed, defining a first and a second stage respectively, the first stage being fed with a flow (13a) that is the mixture of the permeate (4) from the second stage (b) of the first step (I) and the rejection (9a) from the second stage of the second step (IIa);
there being, in turn, an overall permeate (19a) that is the result of mixing an overall permeate (14b) from the second step (IIa) of the first stage (a) of the first step (I) with a permeate (18a) from the second step (IIb) of the second stage (b) of the first step (I);
there being a rejection (16a) form the second step (IIb) of the second stage (b) of the first step (I) that is introduced into the aspiration (8a) of the first step (I); and
there being an overall rejection (3) from the first step (I) that is used in the energy regenerator (26) in order to use the energy of said rejection (3).

11. A process for the desalination and elimination of boron from water according to claim 10, characterised in that in the second steps (IIa, IIb) sodium hydroxide (10) or a strong base, or a strong base and a scale inhibitor (11) are added to feed currents (1, 13a) of these steps, said currents being, current (1) from the membranes of the first stage (a) of the first step (I) and current (13a) the mixture of the rejection (9a) of the second stage of the second step (IIa) and the permeate (4) from the second stage (b) of the first step (I).

12. The equipment to carry out the process of desalination and elimination of boron from water as defined in claim 1, characterised in that it comprises at least:
one reverse osmosis membrane container (9) comprising a plurality of membranes A1, A2, A3, A4, A5, A6 and A7) interconnected in series, these being low pressure and high flow or medium pressure and medium flow seawater or brackish water membranes; a blind interconnector (2) arranged between two membranes of said membrane container (9) such that said interconnector (2) separates the permeate flows of two membrane or stage sections (a and b); and
at least two flow-adjusting valves (5) installed at each side of the membrane container (9) of the first step (I).

13. The equipment to carry out a process of desalination and boron elimination from water according to claim 12, characterised in that the membrane container has 6, 7, or 8 membranes.

14. The equipment to carry out a process of desalination and boron elimination according to claim 12, characterised in that 7 or 8 membranes are placed in the membrane container (9) and the blind interconnector (2) is arranged between the membranes at positions A3-A4 or A4-A5.

15. The equipment according to claim 12 to carry out the process of desalination and elimination of boron from water as defined in claim 8, characterised in that it also comprises:
a hydraulic pressure transfer device (12) inserted in the feed of the second step (II).

16. The equipment according to claim 15 in order to carry out the process of desalination and elimination of boron from water as defined in claim 9, characterised in that it also comprises a low power consumption pump (13) installed in bypass after the hydraulic pressure transfer device (12) and before the feed of the second step (II).

17. The equipment according to claim 12 to carry out the process of desalination and elimination of boron from water as defined in claim 10, characterised in that it also comprises:
at least four reverse osmosis membrane containers (22, 23, 24 and 25) consisting of high rate and low pressure or medium rate and medium pressure brackish water membranes;
a booster pump (16) or low pressure pump inserted in the feed (13a) of the second step (IIb) of the second stage (b) of the first step (I);
an energy regenerator (26) inserted after the rejection (3) from the first step (I), such that it uses the energy of said rejection (3) to propel a flow (20a) coming from the aspiration (8a) to the feed (8) of the membrane container (9) of the first step (I) and
a second booster pump (17) or low pressure pump inserted in the flow (23′) propelled by the energy regenerator (26).
